(19) United States
(12) Patent Application Publication
(10) Pub. No.: US 2023/0239633 A1
(43) Pub. Date: Jul. 27, 2023

(54) MEMS MICROPHONE STRUCTURE AND MANUFACTURING METHOD THEREOF

(71) Applicant: DB HiTek Co., Ltd., Bucheon-si (KR)

(72) Inventor: Sung Joon KIM, Eumseong-gun (KR)

(21) Appl. No.: 18/153,678

(22) Filed: Jan. 12, 2023

(30) Foreign Application Priority Data
Jan. 26, 2022 (KR) 1020220011570

(51) Int. Cl. H04R 19/04; H04R 31/00

(52) U.S. Cl. CPC H04R 19/04; H04R 31/00; H04R 2201/003

(57) ABSTRACT

Disclosed are a MEMS microphone structure and a manufacturing method thereof. More particularly, a MEMS microphone structure and a manufacturing method thereof are disclosed, including a plurality of diaphragms and a plurality of back plates configured alternately in a vertical direction so that the areas of the diaphragms and the back plates are maximized within a limited area, thereby improving overall sensitivity.

### CROSS REFERENCE TO RELATED APPLICATION

The present application claims priority to Korean Patent Application No. 10-2022-0011570, filed Jan. 26, 2022, the entire contents of which are incorporated herein for all purposes by this reference.

### BACKGROUND OF THE INVENTION

### Field of the Invention

The present disclosure relates generally to a MEMS microphone structure and a manufacturing method thereof. More particularly, the present disclosure relates to a MEMS microphone structure and a manufacturing method thereof, including a plurality of diaphragms and a plurality of back plates configured alternately in a vertical direction so that the areas of the diaphragms and the back plates are maximized within a limited area, thereby improving overall sensitivity.

### Description of the Related Art

A microphone is a device that converts sound into an electrical signal, and there are various types of microphones such as a dynamic type, a condenser type, a ribbon type, and a ceramic type. Microphones have been greatly advanced with the development of electric and electronic technologies. In particular, the size of the microphones has become small as the development of small wired and wireless devices has increased. Recently, a microphone using a micro-electro-mechanical system (MEMS, micro-processing technology), called a MEMS microphone, has been developed. The MEMS microphone may be classified into a piezo-type and a capacitive-type. Of these, the capacitive MEMS microphone is mainly used because of its excellent frequency response characteristics within the voice band.

A MEMS microphone generally includes a bendable diaphragm and a back plate that faces the diaphragm. The diaphragm is spaced apart from a substrate and the back plate to freely bend upward or downward in response to sound waves. The diaphragm may have a membrane structure to sense an acoustic pressure and generate a displacement. In other words, when the acoustic pressure arrives at the diaphragm, the diaphragm may bend upward or downward due to the acoustic pressure. The displacement of the diaphragm may be sensed through a change in capacitance between the diaphragm and the back plate. As a result, acoustic pressures such as sound may be converted by the MEMS microphone into an electrical signal for output.

In such a MEMS microphone, the sensitivity, which is the main characteristics of the microphone, may be adjusted by controlling the distance between the diaphragm and the back plate, controlling the area of the diaphragm, or controlling the stiffness of the diaphragm. When maximizing the diaphragm area to improve the sensitivity, a method of arranging a plurality of diaphragms horizontally may be to considered. However, in such a conventional method, there is a limit in the area along the horizontal direction(s) in which the diaphragms can be placed, and thus there is also a limit in improving the sensitivity characteristics.

To overcome the above problems, the present inventors have conceived a novel MEMS microphone with an improved structure and a manufacturing method thereof, which will be described in detail below.

The foregoing is intended merely to aid in the understanding of the background of the present disclosure, and is not intended to mean that the present disclosure falls within the purview of the related art or that it is already known to those skilled in the art.

### DOCUMENTS OF RELATED ART

Korean Patent Application Publication No. 10-2018-0054288, entitled “MEMS microphone chip structure and microphone package.”

### SUMMARY OF THE INVENTION

Accordingly, the present disclosure has been made keeping in mind the above problems occurring in the related art, and an objective of the present disclosure is to provide a MEMS microphone structure and a manufacturing method thereof, including a plurality of diaphragms and a plurality of back plates configured alternately (e.g., alternate) in a vertical direction so that the areas of the diaphragms and the back plates are maximized within a limited area, thereby improving overall sensitivity.

Another objective of the present disclosure is to provide a MEMS microphone structure and a manufacturing method thereof, including which a first support that physically connects a lower diaphragm and an upper diaphragm so that displacements of the lower diaphragm and the upper diaphragm are maintained at substantially the same level when the diaphragms bend in response to an acoustic pressure.

In order to achieve the above objectives, according to one aspect of the present disclosure, there is provided a MEMS microphone structure including a substrate having a cavity in a bending region (e.g., of the substrate or the MEMS microphone structure); a plurality of diaphragms in or over the cavity in the bending region; a plurality of back plates in the bending region; an anchor in contact with the substrate in a support region (e.g., of the substrate or the MEMS microphone structure) and supporting an end of one of the plurality of diaphragms; an insulating film on each of the back plates; and a chamber in contact with the substrate in the support region and supporting an end of one of the plurality of back plates, wherein the plurality of diaphragms and the plurality of back plates may alternate and be spaced apart from each other in a vertical direction.

According to another aspect of the present disclosure, the plurality of back plates may be connected to each other by a support between adjacent back plates, and the support may extend in the vertical direction and comprise an insulating film.

According to another aspect of the present disclosure, the plurality of back plates may be electrically connected to each other by a connector between adjacent back plates, and the connector may extend in the vertical direction and comprise a conductive material.

According to another aspect of the present disclosure, the plurality of diaphragms may be connected to each other by a connector between adjacent diaphragms, and the connector may extend in the vertical direction and comprise a conductive material.

According to another aspect of the present disclosure, the insulating films may be connected to each other by a support between adjacent ones of the insulating films and comprise an insulating material.

According to another aspect of the present disclosure, there is provided a MEMS microphone structure including a substrate having a cavity in a bending region (e.g., of the substrate or the MEMS microphone structure); a lower diaphragm in or over the cavity in the bending region; a lower back plate spaced from the lower diaphragm in the bending region; an upper diaphragm spaced from the lower back plate in the bending region; an upper back plate spaced from the upper diaphragm in the bending region; an anchor in contact with the substrate in a support region (e.g., of the substrate or the MEMS microphone structure) and supporting an end of one of the plurality of diaphragms; an intermediate insulating film on the lower back plate; an upper insulating film on the upper back plate and connected to the intermediate insulating film; and a chamber in contact with the substrate in the support region and supporting an end of one of the plurality of back plates, wherein the upper back plate and the lower back plate may be electrically and mechanically connected to each other, and the lower diaphragm and the upper diaphragm may be electrically and mechanically connected to each other.

According to another aspect of the present disclosure, the lower diaphragm and the upper diaphragm may be electrically connected to each other by a connector passing through a through-hole in the upper back plate, and the connector may have a narrower width than the through-hole.

According to another aspect of the present disclosure, the MEMS microphone structure may further include a lower insulating film on the substrate in a peripheral region (e.g., of the substrate or the MEMS microphone structure); a diaphragm pad on the lower insulating film; and a first electrode on the diaphragm pad.

According to another aspect of the present disclosure, the MEMS microphone structure may further include a sacrificial layer on the lower insulating film; a back plate pad on the sacrificial layer; and a second electrode on the back plate pad.

According to another aspect of the present disclosure, the lower diaphragm and the upper diaphragm may be connected to each other by a connector comprising an insulating material, and the connector may be at or in a center of the lower diaphragm or adjacent to the center.

According to another aspect of the present disclosure, there is provided a MEMS microphone structure including a substrate having a cavity in a bending region; a lower diaphragm in or over the cavity in the bending region (e.g., of the substrate or the MEMS microphone structure); a lower back plate on or over the lower diaphragm; an upper diaphragm on or over the lower back plate; an upper back plate on or over the upper diaphragm; a first support having a first end connected to the lower diaphragm and a second end connected to the upper diaphragm; a first connector having a first end connected to the upper surface of the lower diaphragm and a second end connected to the lower surface of the upper diaphragm, and spaced apart from the first support; and a second connector having a first end connected to the lower back plate and a second end connected to the upper back plate.

According to another aspect of the present disclosure, the MEMS microphone structure may further include an anchor and a vent hole at or close to a boundary between the lower diaphragm and the anchor.

According to another aspect of the present disclosure, the MEMS microphone structure may further include an intermediate insulating film on the lower back plate; a second support; and an upper insulating film on the upper back plate and connected to the intermediate insulating film by the second support.

According to another aspect of the present disclosure, the lower insulating film and the lower back plate may include a plurality of first through-holes spaced apart from each other (e.g., serving as acoustic holes), and the upper insulating film and the upper back plate may include a plurality of second through-holes spaced apart from each other (e.g., serving as additional acoustic holes).

According to another aspect of the present disclosure, there is provided a method of manufacturing a MEMS microphone structure, the method including forming a lower insulating film on a substrate; forming, on the lower insulating film, a lower diaphragm in a bending region (e.g., of the substrate or the MEMS microphone structure), an anchor on the substrate in a support region (e.g., of the substrate or the MEMS microphone structure), and a diaphragm pad on the substrate in a peripheral region (e.g., of the substrate or the MEMS microphone structure); forming a first sacrificial layer on the lower insulating film; forming, on the first sacrificial layer, a lower back plate in the bending region and a back plate pad in the peripheral region; forming an intermediate insulating film on the lower plate and a chamber on the substrate in the support region; forming a second sacrificial layer on the intermediate insulating film, the first sacrificial layer, and the chamber; forming an upper diaphragm on the second sacrificial layer; forming a first connector and a first support in the first sacrificial layer and the second sacrificial layer; forming a third sacrificial layer on the upper diaphragm; forming an upper back plate on the third sacrificial layer; forming an upper insulating film on the upper back plate; and forming a second connector in the second sacrificial layer and the third sacrificial layer.

According to another aspect of the present disclosure, each of the first connector and the first support may have a first end connected to the lower diaphragm and a second end connected to the upper diaphragm.

According to another aspect of the present disclosure, the second connector may have a first end connected to the lower back plate and a second end connected to the upper back plate.

According to another aspect of the present disclosure, the method may further include etching the second sacrificial layer and the third sacrificial layer in the peripheral region to expose upper surfaces of the diaphragm pad and the back plate pad; forming a first electrode on the diaphragm pad; and forming a second electrode on the back plate pad.

According to another aspect of the present disclosure, the method may further include forming a cavity by etching a side or an exposed surface of the substrate; and forming an air gap between the lower back plate and the lower diaphragm and between the upper back plate and the upper diaphragm.

The present disclosure has the following effects by the above configuration.

According to the present disclosure, the plurality of diaphragms and the plurality of back plates are configured alternately (e.g., alternate) in a vertical direction. Thus, it is possible to maximize the areas (or the total exposed surface area) of the diaphragms and the back plates within a limited area, thereby improving overall sensitivity.

Furthermore, the first support physically connects the lower diaphragm and the upper diaphragm. Thus, it is possible to maintain displacements of the lower diaphragm and the upper diaphragm at substantially the same level(s) when the diaphragms bend in response to an acoustic pressure.

Meanwhile, the effects of the present MEMS microphone structure and method(s) disclosed herein are not limited to the effects described above, and other effects not stated directly may be understood from the following description and claims.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a plan view illustrating an exemplary MEMS microphone structure according to an embodiment of the present disclosure;

FIG. 2 is a cross-sectional view illustrating the MEMS microphone structure taken along line A-A′ of FIG. 1; and

FIGS. 3 to 19 are cross-sectional views illustrating an exemplary method of manufacturing a MEMS microphone structure according to one or more embodiments of the present disclosure.

### DETAILED DESCRIPTION OF THE INVENTION

Hereinafter, exemplary embodiments of the present disclosure will be described in more detail with reference to the accompanying drawings. The embodiments of the present disclosure can be modified in various forms. Therefore, the scope of the present disclosure should not be construed as being limited to the following embodiments, but should be construed on the basis of the descriptions in the appended claims. Various embodiments of the present disclosure are provided for complete disclosure of the present disclosure and to fully convey the scope of the present disclosure to those skilled in the art.

As used herein, the singular forms are intended to include the plural forms as well, unless the context clearly indicates otherwise. It will be further understood that the terms “comprise,” “comprising”, etc. when used in this specification, specify the presence of stated features, integers, steps, operations, elements, components, and/or combinations thereof, but do not preclude the presence or addition of one or more other features, integers, steps, operations, elements, components, and/or combinations thereof.

As used herein, when an element (or layer) is referred to as being on another element (or layer), it can be directly on the other element, or one or more intervening elements (or layers) may be therebetween. In contrast, when an element is referred to as being directly on or above another component, no intervening elements are therebetween. Further, the terms “on”, “above”, “below”, “upper”, “lower”, “one side”, “side surface”, etc. are used to describe one element's relationship to one or more other elements illustrated in the drawings.

“MEMS microphone” refers to a structure or configuration that converts sound into an electric signal for output by generating a displacement in a diaphragm in response to an acoustic pressure.

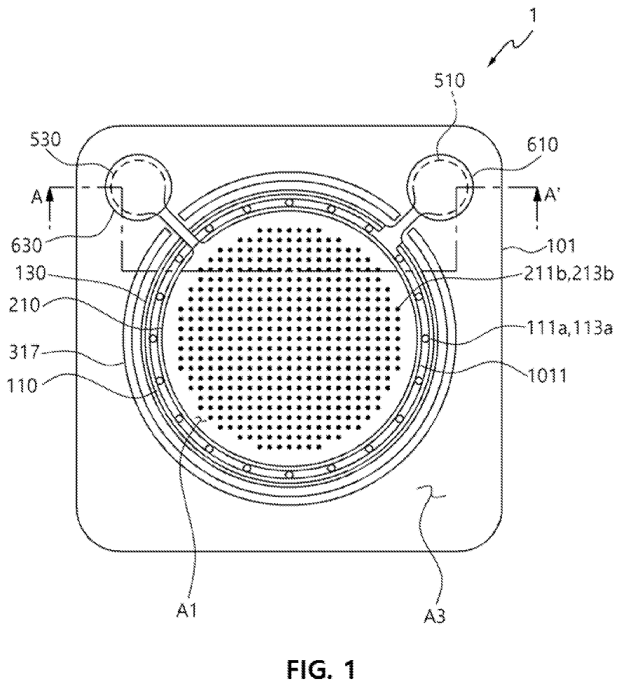

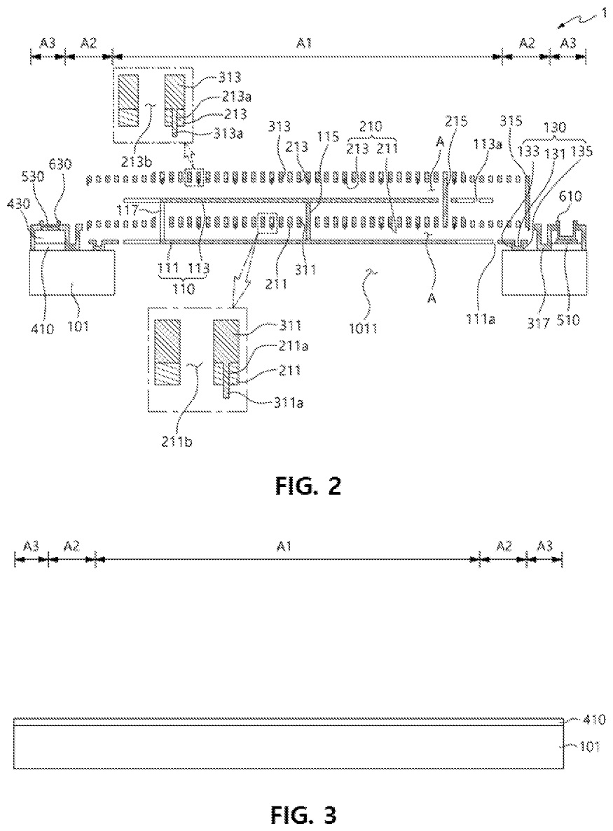

FIG. 1 is a plan view illustrating an exemplary MEMS microphone structure 1 according to one or more embodiments of the present disclosure. FIG. 2 is a cross-sectional view illustrating the exemplary MEMS microphone structure 1 taken along line A-A′ in FIG. 1.

Hereinafter, the MMS microphone structure 1 according to embodiment(s) of the present disclosure will be described in detail with reference to the accompanying drawings.

Referring to FIGS. 1 and 2, the present disclosure relates to the MEMS microphone structure 1. More particularly, the present disclosure relates to the MEMS microphone structure 1, including a plurality of diaphragms 110 and a plurality of back plates 210 configured alternately (e.g., alternate) in a vertical direction, so that the areas of the diaphragms 110 and the back plates 210 are maximized within a limited area (e.g., the area of the bending region A1), thereby improving overall sensitivity. Preferably, the plurality of diaphragms 110 overlap each other in the vertical direction, and the plurality of back plates 210 also overlap each other in the vertical direction, but the present disclosure is not limited thereto.

Referring to FIG. 2, the MEMS microphone structure 1 may include a bending region A1 including a cavity 1011, a support region A2 from the bending region A1 to a periphery of a chamber 317, and a peripheral region A3 surrounding the support region A2. It is to be understood that the support region A2 is a region including components that support the diaphragms 110 and the back plates 210 on a substrate 101.

Describing the structure 1 according to embodiment(s) of the present disclosure, first, a cavity 1011 may be in the substrate 101 to prevent the substrate 101 from interfering with the diaphragms 110 when the diaphragms 110 bend in response to an acoustic pressure. The cavity 1011 may be in the bending region A1 and may have a substantially circular shape in the plan view, but the present disclosure is not limited thereto.

In addition, the diaphragms 110 may be over the cavity 1011 in the substrate 101. In detail, the diaphragms 110 are in the bending region A1 and cover some or most of the cavity 1011, and bend or generate a displacement in response to an acoustic pressure.

The diaphragms 110 may have a substantially circular shape in the plan view (e.g., FIG. 1), and may be at a different position from the substrate 101 (e.g., at a position where they do not overlap with each other in the vertical direction and optionally in the horizontal direction as shown in FIG. 2), thereby preventing substrate interference during displacements of the diaphragms 110. Each of the diaphragms 110 may be doped with impurities on a side or surface thereof corresponding to an associated one of the back plates 210, which will be described later. The doping of the impurities may comprise an ion implantation process.

In addition, the diaphragms 110 may include a lower diaphragm 111 and an upper diaphragm 113 spaced apart from each other in the vertical direction. The lower diaphragm 111 and the upper diaphragm 113 may be at positions with a lower back plate 211 therebetween, which will be described later. In other words, the lower diaphragm 111 may be spaced apart from the lower back plate 211 in a first direction (e.g., downward as shown in FIG. 2), and the upper diaphragm 113 may be spaced apart from the lower back plate 211 in a second direction (e.g., upward as shown in FIG. 2). The upper diaphragm 113 may be between the lower back plate 211 and an upper back plate 213.

As described above, when the lower diaphragm 111 and the upper diaphragm 113 are spaced apart in the vertical direction, the total area of the diaphragms 110 may be maximized within a limited area. Although the aforementioned embodiment(s) include two diaphragms 110, that is, the lower diaphragm 111 and the upper diaphragm 113, the present disclosure is not limited thereto, and if necessary, three or more diaphragms 110 may be spaced apart from each other in the vertical direction. In addition, each of the diaphragms 111 and 113 preferably overlaps each other in the bending region A1.

The lower diaphragm 111 and the upper diaphragm 113 may be connected to each other by a first support 115. The first support 115 physically connects the lower diaphragm 111 and the upper diaphragm 113 to each other. The first support 115 may comprise an insulating film such as a silicon oxide (e.g., doped or undoped silicon dioxide) film or a silicon nitride film, but the present disclosure is not limited thereto. Preferably, the first support 115 comprises the same material as an intermediate insulating film 311 and/or an upper insulating film 313, which will be described later.

In addition, one first support 115 may extend (e.g., have a length or height oriented) in a substantially vertical direction between a center of the lower diaphragm 111 and a center of the upper diaphragm 113, as shown in FIG. 2. Further embodiments may include two or more first supports 115, optionally at predetermined or arbitrary positions. However, the present disclosure is not limited thereto. Thus, when the diaphragms 110 bend by the acoustic pressure, the displacement distance of the lower diaphragm 111 may be constrained or minimized. In other words, the upper and lower diaphragms 111 and 113 may bend by approximately the same displacement.

In addition, the lower diaphragm 111 and the upper diaphragm 113 may also be connected to each other by a first connector 117. The first connector 117 may also extend in the vertical direction, similar to the first support 115, so that a first end thereof is connected to the lower diaphragm 111 and a second end thereof is connected to the upper diaphragm 113. The first connector 117 may be spaced apart from the first support 115 in the horizontal direction, as shown in FIG. 2. The first connector 117 may electrically connect the lower diaphragm 111 and the upper diaphragm 113. The first connector 117 may comprise silicon or another semiconducting material doped with impurities (for example, by an ion implantation process), or may comprise a conductive material such as a metal, but the present disclosure is not limited thereto.

For example, the first connector 117 preferably comprises the same material as the upper and lower diaphragms 111 and 113. Although in the accompanying drawings, the first connector 117 and the first support 115 are on the same vertical plane as a first through-hole 211b and a second through-hole 213b which will be described later, the first connector 117 and the first support 115 may be spaced apart from the first through-hole 211b and the second through-hole 213b in the horizontal direction. Here, it should be noted that they are illustrated together on a single cross-sectional view for convenience of description.

A plurality of first vent holes 111a may pass through the lower diaphragm 111, and a plurality of second vent holes 113a may pass through the upper diaphragm 113. The first vent holes 111a may be at or close to a boundary between the lower diaphragm 111 and the anchor 130. The second vent holes 113a (which may not be shown in FIG. 1) may be at a position substantially matching the first vent holes 111a. The vent holes 111a and 113a may be spaced apart from each other along, for example, a circumferential path (e.g., proximate or adjacent to an outermost circumference or peripheral edge of the corresponding diaphragm 111 or 113), and may serve as movement passages for air in response to the acoustic pressure and resulting displacement(s) of the diaphragms 111 and 113.

In addition, the anchor 130 may be along an end portion or peripheral edge of the lower diaphragm 111. The anchor 130 has a first side or surface on the substrate 101 to support the diaphragms 110 above the cavity 1011. The anchor 130 may have a ring shape in the plan view, and may be in the support region A2. The anchor 130 may include a seat 131 in contact with the substrate 101, an inner wall 133 extending upward from the seat 131 and adjacent to the lower diaphragm 111, and an outer wall 135 on or at an opposite edge of the seat 131 from the inner wall 133 (e.g., along an outermost peripheral edge of the seat 131) and extending upward from the seat 131. The outer wall 135 may surround the inner wall 133. In other words, the outer wall 135 may be at a position relatively close to the peripheral region A3, and the inner wall 133 may be at a position relatively close to the bending region A1. As described above, when the anchor 130 (and, in particular, the seat 131) has a height difference with respect to the inner wall 133 (and optionally the outer wall 135), effective bending and/or displacement of the lower diaphragm 111 may be ensured.

In addition, the back plates 210 may be above the respective/corresponding diaphragms 110. In detail, the lower back plate 211 may be between the lower diaphragm 111 and the upper diaphragm 113, and the upper back plate 213 may be above the upper diaphragm 113 as shown in FIG. 2. Thus, an air gap A may be between the lower back plate 211 and the lower diaphragm 111, and between the upper back plate 213 and the upper diaphragm 113. The number of the back plates 210 may correspond to the number of the diaphragms 110, and the back plates 210 may be in the bending region A1.

In addition, the lower back plate 211 and the upper back plate 213 may be electrically connected to each other by a second connector 215. The second connector 215 may extend in the vertical direction so that a first end thereof is connected to the lower back plate 211 and a second end thereof is connected to the upper back plate 213. In addition, the second connector 215 may pass through a through-hole in the upper diaphragm 113. Here, the through-hole in the upper diaphragm 113 preferably has a width greater than that of the second connector 215 so that the upper diaphragm 113 does not to make contact with the second connector 215. Like the first connector 117, the second connector 215 may also comprise a semiconductor material doped with impurities (for example, by an ion implantation process). In addition, the second connector 215 may comprise the same material as the upper and lower back plates 211 and 213 or may comprise a conductive metal material, but the present disclosure is not limited thereto.

A first tip hole 211a containing a first protective tip 311a may be in the lower back plate 211, and a second tip hole 213a containing a second protective tip 313a may be in the upper back plate 213.

In addition, the insulating films 311 and 313 may be on the respective back plates 210. For example, the intermediate insulating film 311 may be on the lower back plate 211, and the upper insulating film 313 may be on the upper back plate 213. The intermediate insulating film 311 and the upper insulating film 313 may cover the back plates 211 and 213, and may allow the back plates 211 and 213 to hang and/or be fixed in positions spaced apart from the corresponding diaphragms 111 and 113 by a predetermined distance. The insulating films 311 and 313 may be directly or indirectly connected to the chamber 317, which will be described later. The number of insulating films 311 and 313 on the back plates 210 may correspond to the number of the back plates 210.

A plurality of first through-holes 211b may be spaced apart from each other through the lower back plate 211 and the intermediate insulating film 311, and a plurality of second through-holes 213b may be spaced apart from each other through the upper back plate 213 and the upper insulating film 313. The first through-holes 211b and the second through-holes 213b may be at positions matching with each other in the vertical direction, but the present disclosure is not limited thereto. These first through-holes 211b and second through-holes 213b may serve as acoustic holes. Each of a plurality of first protective tips 311a in a corresponding plurality of first tip holes 211a has a bottom part extending below the lower back plate 211 and may be at or on a bottommost surface of the intermediate insulating film 311. Similarly, each of a plurality of second tips 313a in a corresponding plurality of second tip holes 213a has a bottom part extending below the upper back plate 213 and may be at or on a bottommost surface of the upper insulating film 313. The respective tips 311a and 313a may prevent the diaphragms 111 from contacting and possibly adhering to the back plates 211 and 213 when the diaphragms 111 and/or 113 bend or are displaced to a degree or extent that diaphragms 111 and/or 113 might otherwise make contact with the corresponding back plate(s) 211 and/or 213, thereby protecting the diaphragms 111 and 113 and enabling the diaphragms 111 and 113 to return to their initial positions after a maximum displacement.

The intermediate insulating film 311 and the upper insulating film 313 may be physically connected to each other by a second support 315. The second support 315 may comprise an insulating film such as a silicon oxide film (e.g., doped or undoped silicon dioxide) or a silicon nitride film, but the present disclosure is not limited thereto. Preferably, the second support 315 comprises the same material as an intermediate insulating film 311 and/or the upper insulating film 313.

In addition, one second support 315 may extend in a substantially vertical direction between a lateral side of the intermediate insulating film 311 and a lateral side of the upper insulating film 313. Alternatively, two or more second supports 315 may be at predetermined or arbitrary positions. However, the present disclosure is not limited thereto. The second support 315 may be, for example, in the support region A2. The second support 315 may maintain a distance or position of the upper back plate 213 from the lower back plate 211 (which is, in turn, supported by the chamber 317). The second support 315 and the second connector 215 may be at positions spaced apart in the horizontal direction from the first and second through-holes 211b and 213b, and it should be noted that they are illustrated together on a single cross-sectional view for convenience of description.

In addition, the chamber 317 for maintaining the intermediate insulating film 311 at a fixed position (e.g., above the cavity or opening 1011) may be at an end of the intermediate insulating film 311. The chamber 317 has a bottommost surface on the substrate 101 and spaces the back plates 211 and 213 corresponding to the intermediate insulating film 311 and the upper insulating film 313 apart from the diaphragms 111 and 113. The chamber 317 may have, for example, a substantially “C” shape in cross-section, but the present disclosure is not limited thereto. In addition, the chamber 317 may have, for example, a ring shape in the plan view. The chamber 317 may be in the support region A2. In other words, the anchor 130 and the chamber 317 may both be in the support region A2.

A lower insulating film 410 may be on the substrate 101. The lower insulating film 410 has a surface on the substrate 101 and is in the peripheral region A3. In other words, the lower insulating film 410 may be outside the anchor 130 and the chamber 317. In addition, the lower insulating film 410 may be at a lower position vertically than the intermediate insulating film 311, as shown in FIG. 2. A diaphragm pad 510 directly or indirectly connected to the lower diaphragm 111 and the upper diaphragm 113 may be on the lower insulating film 410. The diaphragm pad 510 may comprise a semiconducting material such as silicon (e.g., polysilicon) doped with impurities (e.g., by an ion implantation process).

A sacrificial layer 430 may be on the lower insulating film 410. The sacrificial layer 430 may remain in the peripheral region A3 outside the anchor 130 and the chamber 317. A back plate pad 530 may be on the sacrificial layer 430. The back plate pad 530 may be directly or indirectly connected to the lower back plate 211 and the upper back plate 213, and may comprise a semiconducting material such as silicon (e.g., polysilicon) doped with impurities (e.g., by an ion implantation process).

A first electrode 610 may be on the diaphragm pad 510, and a second electrode 630 may be on the back plate pad 530. The first electrode 610 may be electrically connected to the diaphragm pad 510, and the second electrode 630 may be electrically connected to the back plate pad 530.

FIGS. 3 to 19 are cross-sectional views illustrating structures formed in a method of manufacturing a MEMS microphone structure according to one or more embodiments of the present disclosure.

Hereinafter, the method of manufacturing the MMS microphone structure according to the present disclosure will be described in detail with reference to the accompanying drawings. Each step may be performed in a sequence different from that described herein, and two or more of the steps may be performed substantially simultaneously, but the present disclosure is not limited thereto.

Referring to FIG. 3, first, a lower insulating film 410 may be formed on a substrate 101. The cavity 1011 is not yet formed in the bending region A1 of the substrate 101. The lower insulating film 410 may comprise, for example, an oxide film (e.g., silicon dioxide).

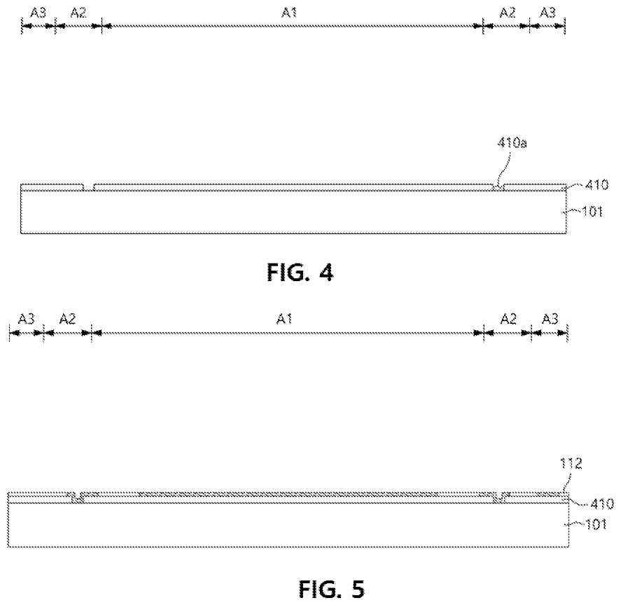

Then, a lower diaphragm 111 and an anchor 130 may be formed on the lower insulating film 410. This will be described in detail. Referring to FIG. 4, first, an anchor recess 410a having a shape complementary to a seat 131, an inner wall 133, and an outer wall 135 of the anchor 130 may be formed in the lower insulating film 410 (e.g., by photolithographic patterning of a photoresist and etching). The anchor recess 410a exposes a portion of the substrate 101 corresponding to a support region A2. The anchor recess 410a may have, for example, a circular or ring shape in the plan view.

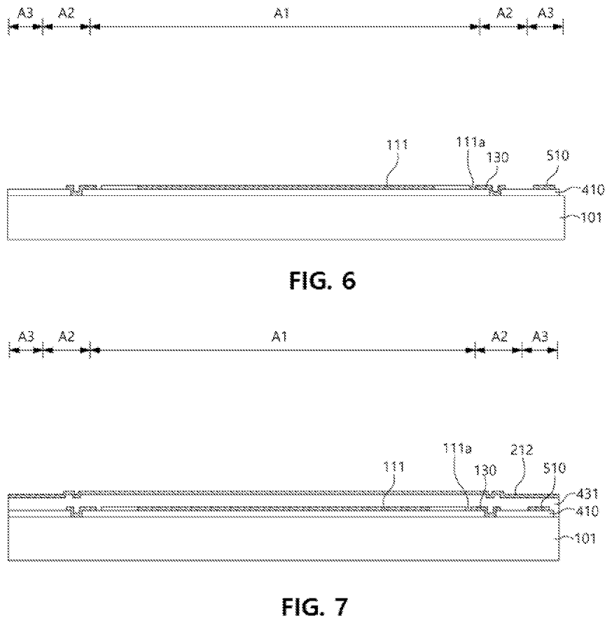

Then, referring to FIG. 5, a first silicon layer 112 may be deposited on the lower insulating film 410 and inside the anchor recess 410a (e.g., by blanket and/or conformal deposition, such as chemical vapor deposition [CVD] using silane gas, physical vapor deposition [PVD] or sputtering using an elemental silicon target, etc.). The first silicon layer 112 may comprise, for example, a polysilicon layer, and may be deposited in the bending region A1, the support region A2, and the peripheral region A3. The first silicon layer 112 may be doped with impurities by ion implantation process (optionally, through a photolithographically-patterned photoresist). The impurity-doped first silicon layer 112 may be in each of the bending region A1, the support region A2, and the peripheral region A3. Then, referring to FIG. 6, the lower diaphragm 111, the anchor 130, and a diaphragm pad 510 may be formed by photolithographic patterning of a photoresist and etching the first silicon layer 112. A vent hole 111a may also be formed in the lower diaphragm 111 in this patterning and etching process.

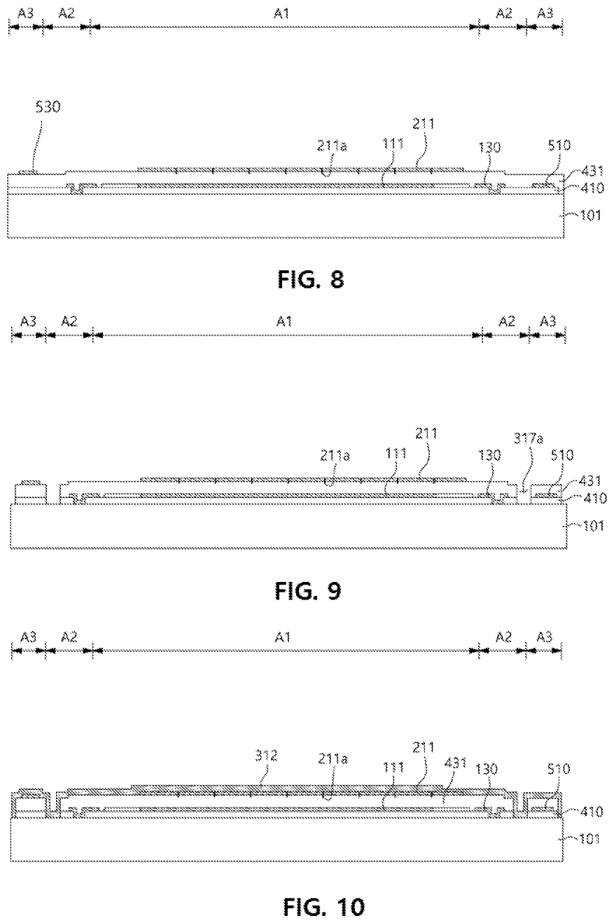

Then, referring to FIG. 7, a first sacrificial layer 431 may be deposited on the lower insulating film 410, the lower diaphragm 111, the anchor 130, and the diaphragm pad 510 (e.g., by blanket and/or conformal deposition, such as chemical vapor deposition [CVD]). Preferably, the first sacrificial layer 431 comprises a material that is selectively etched relative to silicon, such as silicon dioxide formed from tetraethyl orthosilicate (TEOS), silicon nitride, etc. Thereafter, a lower back plate 211 and a back plate pad 530 may be formed on the first sacrificial layer 431. This will be described in detail. Referring to FIG. 7, a second silicon layer 212 may be deposited on the first sacrificial layer 431 (e.g., by blanket and/or conformal deposition, as described herein). Thereafter, the second silicon layer 212 may be doped with impurities by an ion implantation process. Then, referring to FIG. 8, the lower back plate 211 and the back plate pad 530 may be formed by photolithographic patterning and etching the first-second silicon layer 212. A plurality of first tip holes 211a may also be formed in the lower back plate 211, and the sacrificial layer 431 exposed by the first tip holes 211a may be etched to a predetermined depth (e.g., in the same patterning and etching process or a subsequent patterning and etching process), thereby forming a plurality of recesses in the sacrificial layer 431.

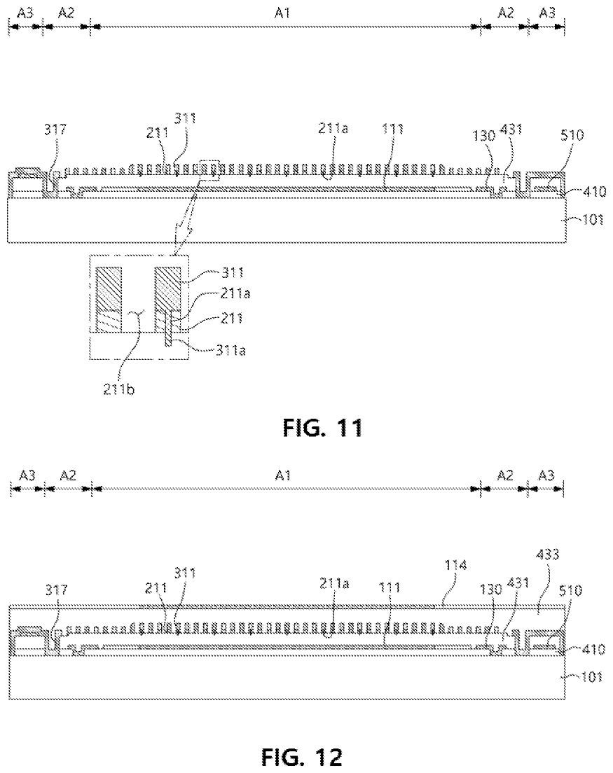

Thereafter, an intermediate insulating film 311 and a chamber 317 may be formed. This will be described in detail. Referring to FIG. 9, the lower insulating film 410 in the support region A2 corresponding to a region where the chamber 317 is to be formed may be etched (after photolithographic patterning of a photoresist) to form a chamber region 317a. Part of the substrate 101 may be exposed by the chamber region 317a. Then, referring to FIG. 10, an intermediate insulating layer 312 may be deposited on the first sacrificial layer 431 (e.g., by blanket and/or conformal deposition, as described herein). The intermediate insulating layer 312 may comprise a material that is selectively not etched relative to the first sacrificial layer 431 (e.g., during subsequent removal of the first sacrificial layer 431). Then, referring to FIG. 11, the intermediate insulating film 311 and the chamber 317 may be formed by photolithographic patterning of a photoresist and etching the intermediate insulating layer 312. During the deposition of the intermediate insulating layer 312, the intermediate insulating layer 312 may fill the first tip holes 211a and the recesses in the first sacrificial layer 431 to form the first tips 311a. During the formation of the intermediate insulating film 311, the lower back plate 211 and the intermediate insulating film 311 may be etched to form a plurality of first through-holes 211b. As described above, the first through-holes 211b may serve as acoustic holes.

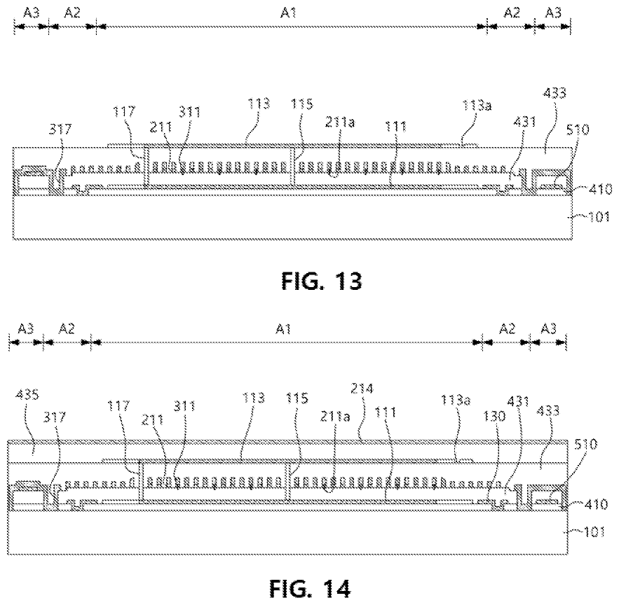

Then, referring to FIG. 12, a second sacrificial layer 433 may be deposited on the intermediate insulating film 311, the first sacrificial layer 431, and the chamber 317, and the second sacrificial layer 433 is then planarized (e.g., by chemical mechanical polishing [CMP]). The second sacrificial layer 433 may comprise the same material as the first sacrificial layer 431. A third silicon layer 114 may be deposited on the second sacrificial layer 433 (e.g., by blanket deposition, as described herein). The third silicon layer 114 may be doped with impurities by an ion implantation process (e.g., through a patterned photoresist exposing the silicon layer 114 in the bending region A1). Then, referring to FIG. 13, an upper diaphragm 113 may be formed by etching the silicon layer 114 (e.g., after photolithographically patterning a photoresist to expose the silicon layer 114 in at least the support region A2 and the peripheral region A3). A second vent hole 113a may be formed in the upper diaphragm 113 in the same patterning and etching process or a different patterning and etching process. The second vent hole 113a may serve as a passage for air movement in response to displacement of the diaphragms 111 and 113 due to an acoustic pressure. The first sacrificial layer 431 and the second sacrificial layer 433 may be etched to form a plurality of contact holes (not illustrated) through which a first connector 117 and a first support 115 pass. The first connector 117 and the first support 115 may be formed by filling the contact holes with the corresponding materials described elsewhere herein (not illustrated). A detailed description thereof will be omitted.

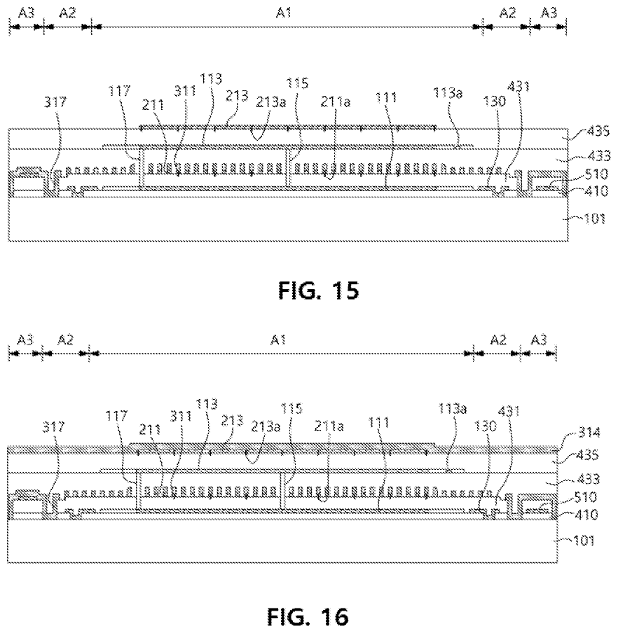

Then, referring to FIG. 14, a third sacrificial layer 435 may be deposited on the upper diaphragm 113, and a fourth silicon layer 214 may be deposited on the third sacrificial layer 435. The fourth silicon layer 214 in the bending region A1 may be doped with impurities by ion implantation (optionally following photolithographic patterning of a photoresist). Then, referring to FIG. 15, the fourth silicon layer 214 may be photolithographically patterned and etched to form an upper back plate 213. A plurality of second tip holes 213a may be formed in the upper back plate 213, and the third sacrificial layer 435 may be etched to a predetermined depth at positions matching with the second tip holes 213a to form a plurality of recesses into which a plurality of second tips 313a are deposited.

Then, referring to FIG. 16, an upper insulating layer 314 may be deposited along upper surfaces of the third sacrificial layer 435 and the upper back plate 213. the upper insulating layer 314 may fill the inside of the second tip holes 213a to form the second tips 313a.

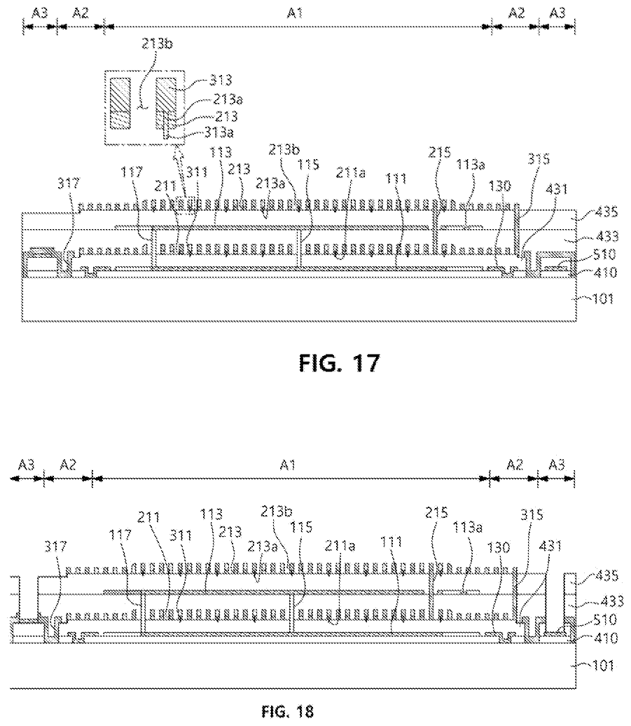

Then, referring to FIG. 17, the upper back plate 213 and the upper insulating layer 314 may be photolithographically patterned and etched to form a plurality of second through-holes 213b. As a result, an upper insulating film 313 may be completed. The second sacrificial layer 433, the third sacrificial layer 435, and the upper back plate 213 may be etched to form a plurality of contact holes (not illustrated) through which a second connector 215 and a second support 315 pass. The second connector 215 and the second support 315 may be formed by filling the contact holes (not illustrated).

Then, referring to FIG. 18, following photolithographic patterning of a photoresist to expose part of the third sacrificial layer 435 in the peripheral region A3, the third sacrificial layer 435, the second sacrificial layer 433, the intermediate insulating layer 312 and the first sacrificial layer 431 may be etched to expose the diaphragm pad 510 and the back plate pad 530.

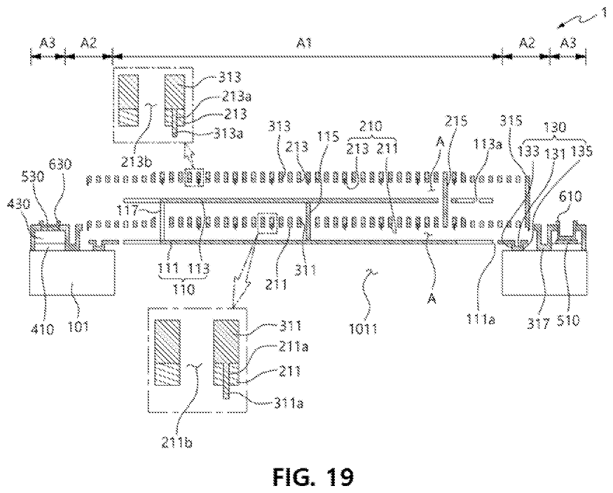

Then, referring to FIG. 19, a first electrode 610 and a second electrode 630 may be respectively formed on the pads 510 and 530 (e.g., by sputtering, electroplating or electroless plating of a conductive material onto the diaphragm pad 510 and the back plate pad 530 following etching of the third sacrificial layer 435, the second sacrificial layer 433, the intermediate insulating layer 312 and the first sacrificial layer 431, but before removal of the patterned photoresist). Following photolithographic patterning of a photoresist on the underside of the substrate 101 exposing the substrate 101 in the bending region A1, the substrate 101 may be etched to form a cavity 1011 to expose the lower insulating film 410. The sacrificial layers 431, 433, and 435 and the lower insulating film 410 in the bending region A1 and the support region A2 may be removed by wet etching using an etchant such as hydrogen fluoride vapor (e.g., when each of the sacrificial layers 431, 433, and 435 and the lower insulating film 410 comprises silicon dioxide). All exposed surfaces of the sacrificial layers 431, 433, and 435 and the lower insulating film 410, including those exposed through openings in the structure, may be etched to provide a flow path of the etching fluid for removing all of the sacrificial layers 433 and 435 and removing the sacrificial layer 431 and the lower insulating film 410 in the bending region A1 and the support region A2.

The foregoing detailed description may be merely an example of the present disclosure. Also, the inventive concept(s) are explained by describing various embodiments, and can be used through various combinations, modifications, and environments. That is, the inventive concept(s) may be amended or modified without departing from the scope of the technical idea and/or knowledge in the art. The foregoing embodiments are for illustrating various modes for implementing the technical idea(s) of the present disclosure, and various modifications may be made therein according to specific applications and fields of use of the present disclosure. Therefore, the foregoing detailed description of the present disclosure is not intended to limit the inventive concept to the disclosed embodiments.

What is claimed is:

1. A MEMS microphone structure comprising:
a substrate having a cavity in a bending region;
a plurality of diaphragms in or over the cavity in the bending region;
a plurality of back plates in the bending region;
an anchor in contact with the substrate in a support region and supporting an end of one of the plurality of diaphragms;
an insulating film on each of the back plates; and
a chamber in contact with the substrate in the support region and supporting an end of one of the plurality of back plates,
wherein the plurality of diaphragms and the plurality of back plates alternate and are spaced apart from each other in a vertical direction.

2. The MEMS microphone structure of claim 1, wherein the plurality of back plates are connected to each other by a first support between adjacent ones of the back plates, and
the first support extends in the vertical direction and comprises an insulator.

3. The MEMS microphone structure of claim 2, wherein the plurality of back plates are electrically connected to each other by a first connector between the adjacent ones of the back plates, and
the first connector extends in the vertical direction and comprises a conductive material.

4. The MEMS microphone structure of claim 1, wherein the plurality of diaphragms are connected to each other by a second connector between adjacent ones of the diaphragms, and
the second connector extends in the vertical direction and comprises a conductive material.

5. The MEMS microphone structure of claim 4, wherein the insulating films are connected to each other by a second support between adjacent ones of the insulating films and comprise an insulating material.

6. A MEMS microphone structure comprising:
a substrate having a cavity in a bending region;
a lower diaphragm in or over the cavity in the bending region;
a lower back plate spaced from the lower diaphragm in the bending region;
an upper diaphragm spaced from the lower back plate in the bending region;
an upper back plate spaced from the upper diaphragm in the bending region;
an anchor in contact with the substrate in a support region and supporting an end of one of the plurality of diaphragms;
an intermediate insulating film on the lower back plate;
an upper insulating film on the upper back plate and connected to the intermediate insulating film; and
a chamber in contact with the substrate in the support region and supporting an end of one of the plurality of back plates,
wherein the upper back plate and the lower back plate are electrically and mechanically connected to each other, and
the lower diaphragm and the upper diaphragm are electrically and mechanically connected to each other.

7. The MEMS microphone structure of claim 6, wherein the lower diaphragm and the upper diaphragm are electrically connected to each other by a connector passing through a through-hole in the upper back plate, and
the connector has a narrower width than the through-hole.

8. The MEMS microphone structure of claim 6, further comprising:
a lower insulating film on the substrate in a peripheral region;
a diaphragm pad on the lower insulating film; and
a first electrode on the diaphragm pad.

9. The MEMS microphone structure of claim 8, further comprising:
a sacrificial layer on the lower insulating film;
a back plate pad on the sacrificial layer; and
a second electrode on the back plate pad.

10. The MEMS microphone structure of claim 6, wherein the lower diaphragm and the upper diaphragm are connected to each other by a connector comprising an insulating material, and
the connector is at a center of the lower diaphragm or adjacent to the center.

11. A MEMS microphone structure comprising:
a substrate having a cavity in a bending region;
a lower diaphragm in or over the cavity in the bending region;
a lower back plate on the lower diaphragm;
an upper diaphragm on the lower back plate;
an upper back plate on the upper diaphragm;
a first support having a first end connected to the lower diaphragm and a second end connected to the upper diaphragm;
a first connector having a first end connected to the lower diaphragm and a second end connected to the upper diaphragm, and spaced apart from the first support; and
a second connector having a first end connected to the lower back plate and a second end connected to the upper back plate.

12. The MEMS microphone structure of claim 11, further comprising an anchor and a vent hole at or close to a boundary between the lower diaphragm and the anchor.

13. The MEMS microphone structure of claim 11, further comprising:
an intermediate insulating film on the lower back plate; and
an upper insulating film on the upper back plate and connected to the intermediate insulating film by a second support.

14. The MEMS microphone structure of claim 13, wherein the lower insulating film and the lower back plate comprise a plurality of first through-holes spaced apart from each other, and
the upper insulating film and the upper back plate comprise a plurality of second through-holes spaced apart from each other.

15. A method of manufacturing a MEMS microphone structure, the method comprising:
forming a lower insulating film on a substrate;
forming, on the lower insulating film, a lower diaphragm in a bending region, an anchor on the substrate in a support region, and a diaphragm pad on the substrate in a peripheral region;
forming a first sacrificial layer on the lower insulating film;
forming, on the first sacrificial layer, a lower back plate in the bending region and a back plate pad in the peripheral region;
forming an intermediate insulating film on the lower plate and a chamber on the substrate in the support region;
forming a second sacrificial layer on the intermediate insulating film, the first sacrificial layer, and the chamber;
forming an upper diaphragm on the second sacrificial layer;
forming a first connector and a first support in the first sacrificial layer and the second sacrificial layer;
forming a third sacrificial layer on the upper diaphragm;
forming an upper back plate on the third sacrificial layer;
forming an upper insulating film on the upper back plate; and
forming a second connector in the second sacrificial layer and the third sacrificial layer.

16. The method of claim 15, wherein each of the first connector and the first support has a first end connected to the lower diaphragm and a second end connected to the upper diaphragm.

17. The method of claim 16, wherein the second connector has a first end connected to the lower back plate and a second end connected to the upper back plate.

18. The method of claim 15, further comprising:
etching the second sacrificial layer and the third sacrificial layer in the peripheral region to expose upper surfaces of the diaphragm pad and the back plate pad;
forming a first electrode on the diaphragm pad; and
forming a second electrode on the back plate pad.

19. The method of claim 18, further comprising:
forming a cavity by etching a side or an exposed surface of the substrate; and
forming an air gap between the lower back plate and the lower diaphragm and between the upper back plate and the upper diaphragm.
